(19) United States
(12) Patent Application Publication
(10) Pub. No.: US 2012/0222514 A1
(43) Pub. Date: Sep. 6, 2012

(54) TOOTHED GEAR WHEEL WITH EXCHANGEABLE TOOTHING

(76) Inventors: Thomas Ehben, Friedeburg (DE); Jan-Dirk Reimers, Aachen (DE)

(21) Appl. No.: 13/401,936

(22) Filed: Feb. 22, 2012

(30) Foreign Application Priority Data
Mar. 2, 2011 (EP) 11156615

(51) Int. Cl. F16H 55/12

(52) U.S. Cl. 74/439

(57) ABSTRACT

A toothed gear wheel with toothed wheel body and exchangeable teeth is disclosed. One or more teeth are embodied as a component which is able to be detachably connected to the toothed wheel body of the toothed gear wheel. A transmission embodied with the toothed gear wheel is disclosed. A component with suitable for use in a toothed gear wheel with toothed wheel body is also disclosed.

### CROSS REFERENCE TO RELATED APPLICATIONS

This application claims priority of European Patent Office application No. 11156615.4 EP filed Mar. 2, 2011. All of the applications are incorporated by reference herein in their entirety.

### FIELD OF INVENTION

The present invention relates to a toothed gear wheel with toothed wheel body and exchangeable teeth. The invention further relates to transmissions with toothed gear wheels with exchangeable teeth.

### BACKGROUND OF INVENTION

Toothed gear wheels in high-performance transmissions (e.g. for ship's drives, wind turbine transmissions, lifting mechanisms) are subjected to high mechanical stresses which can lead to wear and to a limited service life. A point-type overloading in the sense of a static damage load from operation is a particular problem, but a cyclic long-term load during operation is also a problem, which can spread from local material imperfections such as occlusions, notches or stiffness cracks (internal notches) into material damage. This damage can be spread by the permanent rolling of the teeth over one another.

Further mechanisms for damage are so-called false brinelling or transport damage which can arise not because of the teeth rolling over one another or operation but through entirely static or quasi-static contacts between the toothing during transport, spinning of a wind turbine or binding of a lifting mechanism. This also involves yaw and pitch drives for wind turbines in particular, which in principle have constant static tooth contact at one operating point which is loaded in this way. This damage too can and will be spread by teeth rolling over one another and transmitted to other toothing if suitable measures cannot be taken.

This can lead to damage to the tooth edges or to teeth breaking Known forms of damage are for example pittings, broken tooth edges and broken tooth feet as well as micropittings. This overload damage or signs of wear generally leads within a short time to complete transmission failure, since further teeth and as a result the bearings as well quickly suffer through a snowball effect from direct mechanical engagement and contamination of the lubricating oil by remains of teeth. This results in expensive repairs.

As well as the use of high-quality materials and also high-quality and filtered lubricating oil, to prevent the spread of damage from the onset of damage to teeth, it is above all a matter of immediately exchanging defective toothed wheels if initial damage is able to be identified to one or more teeth. This method is however limited for specific applications, e.g. if easy access to the toothed wheels is prevented. This is the case for example if replacing a toothed wheel makes it necessary to disassemble a large, heavy surrounding overall system or if the overall system, as a result of environmental conditions, is only accessible to a restricted extent, e.g. for offshore wind turbines or with ship's drives.

### SUMMARY OF INVENTION

The object of the present invention is to provide toothed gear wheels and gearing which are simple to maintain.

This object is achieved by a toothed gear wheel with a toothed wheel body and exchangeable teeth, with one or more teeth being embodied as a component which is able to be connected by means of a detachable connection to the tooth wheel body of the toothed wheel. Worn or broken teeth of toothed wheels can thus be easily exchanged without the entire toothed wheel having to be exchanged.

A first advantageous embodiment of the invention lies in the detachable connection being made by a radial or an axial screw fixing. Screw fixings make it possible to connect the component to the toothed wheel body quickly and easily. Depending on accessibility in the gearing the screw fixing can be made radially and/or axially.

A further advantageous embodiment of the invention lies in the detachable connection being made by a mortise and tenon joint making a form fit between component and toothed wheel body. This makes an especially good transmission of the tooth force to the wheel body possible.

A further advantageous embodiment of the invention lies in adjacent components being connected to one another.

This enhances the overall stability of the toothed wheel assembly.

A further advantageous embodiment of the invention lies in adjacent components being connected to each other by a form-fit mortise and tenon joint and/or by a screw fixing. This increases the overall stability of the toothed wheel assembly even further.

A further advantageous embodiment of the invention lies in additional exchangeable tooth covers being provided. Exchangeable tooth covers are especially a provisional or emergency solution for keeping the failure time or downtime of a transmission low or for continuing operation with restricted performance.

A further advantageous embodiment of the invention lies in providing exchangeable tooth covers instead of exchangeable teeth. Exchangeable tooth covers are especially a provisional measure or emergency solution, to keep the failure time or downtime of a transmission low or continue operation with restricted performance until the tooth or the gear is replaced completely.

A further advantageous embodiment of the invention lies in the toothing material consisting of a material with different characteristics in respect of resilience or hardness from the toothed wheel body. The basic body of the toothed wheel can consist of a simpler and thus lower cost material (e.g. cast-iron) than the toothing (e.g. steel) since a greater mechanical stress arises in the area of the toothing. This especially enables savings in manufacturing costs. Furthermore the basic body can for example be manufactured by shaping (e.g. forging, pressing) and the toothing by a metal working method (e.g. generating).

A further advantageous embodiment of the invention lies in the fact that the components (segments or exchangeable segments) each have different numbers of teeth. In this way inherent frequency excitations are avoided and force and torque impacts as a result of variations in shape are better distributed and do not become more frequent.

A further advantageous embodiment of the invention lies in the number of teeth per component (segment or exchangeable segment) being a primary number. In this way inherent frequency excitations are prevented or avoided.

The object is further achieved by gearing with toothed gear wheels, with at least one toothed gear wheel being embodied in accordance with the claims. Gearing with toothed wheels with exchangeable teeth is especially easy to maintain since the toothed wheel does not have to be exchanged completely. In addition it costs less to exchange teeth than to exchange a complete toothed gear wheel.

The object is further achieved by a transmission with toothed gear wheels, wherein in a toothed wheel pairing comprising a first toothed gear wheel and a second toothed gear wheel, only the first toothed gear wheel is embodied in accordance with the claims, wherein the component with the exchangeable teeth and/or exchangeable tooth covers is made from a softer material than the second toothed gear wheel. In particular with an especially highly-stressed toothed wheel pairing it makes sense to only equip one of the toothed wheels with the inventive exchangeable toothed wheels, the teeth of which are manufactured from a softer material than the other conventional hard-tooth wheel. Thus the exchangeable toothed wheel acts as a sacrificial toothed wheel. It can be assumed during operation that its teeth will exhibit signs of wear first. While its teeth can be exchanged at low cost, the other toothed wheel can be manufactured in possibly the less expensive conventional manner.

The object is further achieved by gearing with toothed gear wheels, wherein in a of toothed wheel pairing comprising a first toothed gear wheel and a second toothed gear wheel, both toothed gear wheels are embodied according the claims, and whereby the distribution of the teeth to the components (segments) in each toothed gear wheel (exchangeable toothed gear wheel) differs from one another. In this way inherent frequency excitations are avoided and force and torque impacts as a result of variations in shape are better distributed or do not become more frequent.

The object is further achieved by a component with one or more exchangeable teeth suitable for use in a toothed gear wheel (exchangeable-tooth wheel) with toothed wheel body, wherein the component is able to be connected by means of a detachable connection to the toothed wheel body of the toothed gear wheel. In the event of damage to a tooth the component can be exchanged like an exchangeable tool or the damaged tooth can be exchanged. It is not necessary to exchange the entire toothed gear wheel.

### BRIEF DESCRIPTION OF THE DRAWINGS

An exemplary embodiment of the invention is shown in the drawing and explained below.

The figures show:

FIG. 1 a schematic overview diagram of the basic structure of a toothed wheel with exchangeable toothing,

FIG. 2 a second typical toothed wheel and typical connections between the tooth segments (components) and the basic body or with each other, and

FIG. 3 a further exemplary embodiment for a connection between the tooth segments and the base body similar to an interchangeable tool.

### DETAILED DESCRIPTION OF INVENTION

According to the invention a toothed gear wheel with the exchangeable teeth or tooth covers is proposed. In the invention one or more teeth in each case is connected as a component by means of a detachable connection to a toothed wheel body. The detachable connection may consists of an axial or radial screw fixing. In a particular embodiment wheel core and tooth segment are provided with a form-fit mortise and tenon joint, which transmits the tooth force to the wheel body especially well. In a further particular embodiment adjacent tooth segments are provided in each case with a form-fit mortise and tenon joint which increases the overall stability of the toothed wheel assembly. A further embodiment makes provision for gearing in which, for an especially highly-stressed toothed wheel pairing, only one of the toothed wheels is equipped with the inventive exchangeable toothed wheels and its teeth are manufactured from a softer material than those of the other conventional toothed wheel with hard teeth. The exchangeable toothed wheel thus acts as a sacrificial toothed wheel. It can be assumed during operation that its teeth will exhibit signs of wear first. While its teeth can be exchanged with little effort, the other toothed wheel can be manufactured in a possibly less expensive conventional design. In a further embodiment of the invention, in an advantageous manner the material can be adapted to the requirements of the load, by the toothing being manufactured from an especially loadable toothing material (e.g. steel) and the basic body able to consist of a simpler and therefore lower-cost material (e.g. cast iron) This also doesn't have to consist of metal if the hub in its turn is likewise fitted to allow it to be detached. This makes a further advantageous embodiment achievable in which the characteristics of the basic body can be modified in accordance with the operational requirements of the vibration values, damping, deformation or similar operationally-relevant characteristics.

In a further advantageous embodiment the transmission is equipped with status monitoring for identifying the damage. Vibration values or particle rates can be used here for identification. The said embodiments can be combined with each other in any given way.

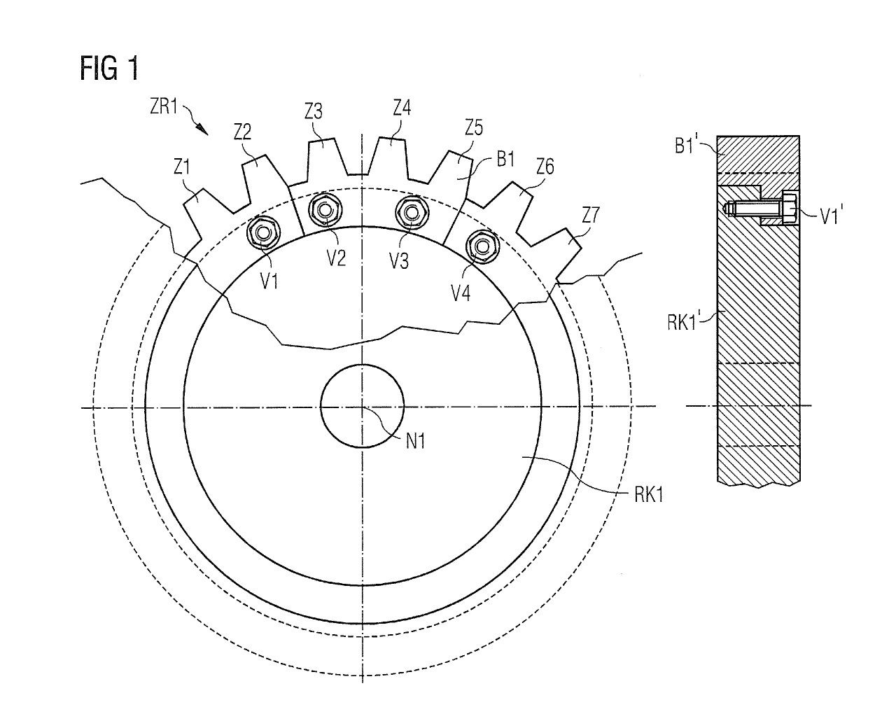

FIG. 1 shows a schematic overview diagram of the basic structure of a toothed wheel ZR1 with exchangeable toothing. The toothed gear wheel ZR1 is usually attached by a hub N1 to an axle or shaft and comprises a toothed wheel body RK1, RK1′ and exchangeable teeth Z1-Z1, with one or more teeth Z1-Z7 being embodied as a component B1, B1′ which is able to be connected by means of a detachable connection V1-V4, V1′ to the toothed wheel body RK1, RK1′ of the toothed gear wheel ZR1. The detachable connection V1-V4, V1′ of the component B1, B1′ with the toothed wheel body RK1, RK1′ can for example be made by a radial and/or an axial screw connection. The detachable connection V1-V4, V1′ can also be made or be made instead of or combined with the screw fixing by mortise and tenon joints making a form fit with each other between component B1, B1′ and toothed wheel body RK1. RK1′.

In order to achieve a greater stability of the wheel ZR1, adjacent components B1, B1′ are advantageously connected to one another. The stability of the wheel ZR1 is further increased if adjacent components B1, B1′ are connected to one another by a form-fit mortise and tenon joint and/or by a screw fixing.

Exchangeable tooth covers can be provided on the teeth Z1-Z7, for all or for a subset of the teeth Z1-Z7.

The option of exchangeability relates to the teeth Z1-Z7 themselves and to the components B1, B1′ to which the teeth are attached. Thus a segment (component) bearing teeth can be exchanged, or individual teeth.

The right-hand part of FIG. 1 shows an example of a detailed view of the screw connection V1′ of a component B1′ with the wheel body RK1′.

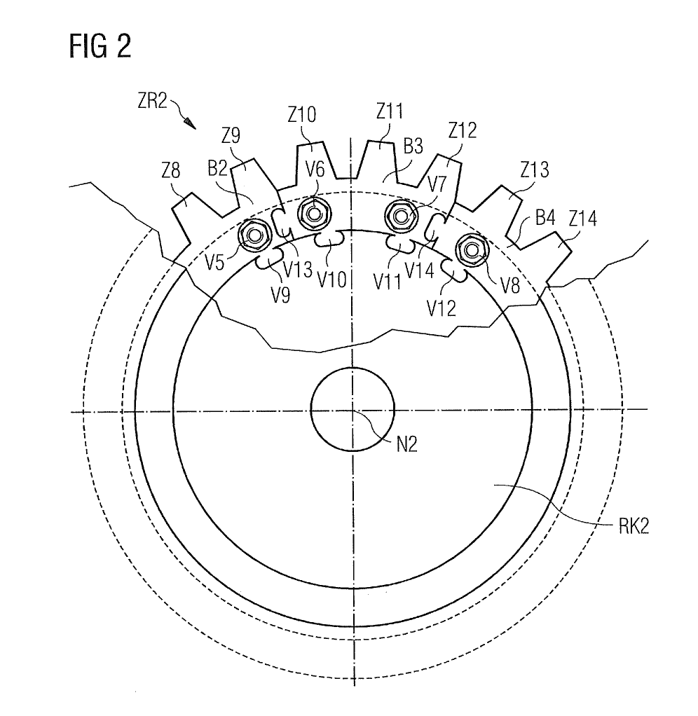

FIG. 2 shows a second typical toothed wheel ZR2 and typical connections between the tooth segments (components) B2-B4 and the basic body or one another respectively. The toothed wheel ZR2 is supported on a hub N2. The two segments (components) B2-B4 are screwed to the basic body RK2 by the connections V5-V8 and/or mortised into the basic body RK2 by the connections V9-V12. A mortise and tenon joint may be used for reasons of grip and stability. Mortise and tenon joints can be easily established by pushing or pressing. Optionally the tooth segments (components) B2-B4 can also be mortised into each other (preferably making a form fit). This increases the stability of the components B2-B4 and of the wheel ZR2.

The option of exchangeability also relates in the example according to FIG. 2 to the teeth Z8-Z14 themselves and to the components B2-B4 to which the teeth Z8-Z14 are attached.

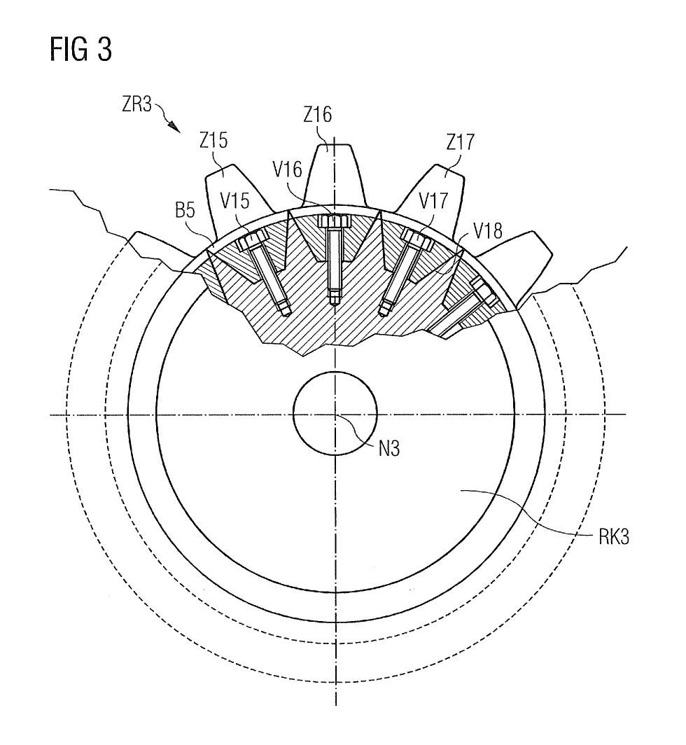

FIG. 3 shows a further exemplary embodiment for a connection between the tooth segments (component B5 with teeth Z15-Z17) with the base body RK3 in a similar manner to an interchangeable tool. The teeth Z15-Z17 are attached in the component B5 by the connections V15-V18. Screw fixings and/or form-fit mortise and tenon joints can be used as connections V15-V18 for example. Advantageously a tapered split dowel can be used for fitting and centering the teeth. It is proposed in FIG. 3 that the procedure for exchanging a component B5 be the same as that for an interchangeable tool. The wheel body RK3 of the toothed gear wheel ZR3 is provided in this case with a chuck into which the component B5 can be clamped and fixed between jaws. The corresponding geometrical design of the chuck and of the component B5 (e.g. the chuck can have the form of a funnel and the component the form of a cone) enables easy introduction of the component B5 into the chuck. This in its turn makes a precise fit and centering of the component B5 in the wheel body RK3 possible. It is also possible to exchange individual teeth Z15-Z17 in a similar way to an interchangeable tool.

The invention has the following particular advantages:
A toothed wheel which is starting to show damage to one or more teeth no longer has to be exchanged completely instead the damage teeth or groups of teeth can be replaced by new parts while the wheel body remains on its shaft.
The dismantling or even the exchange of the gearing can be avoided in this way.
The usable life or service life of the gearing can thus be significantly extended since tooth damage causes a significant part of the transmission damage occurring in practice or an interaction with consequent damage to bearings occurs, which can likewise be reduced if initial damage could be rectified in a simple manner.
It also results in significant savings in material over the entire life cycle of the transmission. There are also advantages for manufacturing the transmission. Toothed wheel bodies and teeth can be made of different materials and a surface hardening can be restricted to the teeth or groups of teeth, whereby the material volumes and masses to be thermally treated are greatly reduced.
Finally the benefit emerges that cracks in the tooth segments cannot spread to the wheel core or adjacent segments since there is no material-to-material connection.

Toothed gear wheel with toothed wheel body and exchangeable teeth, wherein one or more teeth are embodied as a component which is able to be connected by means of a detachable connection to the toothed wheel body of the toothed gear wheel. Gearing with toothed gear wheels embodied in this manner. Component with one or more exchangeable teeth suitable for use in a toothed gear wheel with toothed wheel body, wherein the component is able to be connected by means of a detachable connection to the toothed wheel body of the toothed gear wheel.

### REFERENCE CHARACTERS

ZR1-ZR3 Toothed gear wheel
Z1-Z17 Tooth
RK1-RK3, RK1′ Wheel body
N1-N3 Hub
B1-B4, B1′ Component
V1-V18, V1′ Connection

1. A toothed gear wheel, comprising:
a toothed wheel body; and
exchangeable teeth,
wherein one or more exchangeable teeth are embodied as a component which is detachably connected to the toothed wheel body of the toothed gear wheel

2. The toothed gear wheel as claimed in claim 1,
wherein the component is detachably connected by a radial or axial screw connection.

3. The toothed gear wheel as claimed in claim 1,
wherein the component detachably connected by a mortise and tenon joint making a form fit between component and toothed wheel body.

4. The toothed gear wheel as claimed in claim 1,
wherein components adjacent on the toothed wheel body are connected to one another.

5. The toothed gear wheel as claimed in claim 4,
wherein the adjacent components are connected to one another by a form-fit mortise and tenon joint and/or by a screw fixing.

6. The toothed gear wheel as claimed in claim 1, further comprising:
an exchangeable tooth cover.

7. The toothed gear wheel as claimed in claim 1,
wherein the exchangeable teeth are formed of a material with different characteristics in respect of resilience and hardness from a material of the toothed wheel body.

8. The toothed gear wheel as claimed in claim 1,
wherein a plurality of components are formed from the exchangeable teach each of the plurality of components have different numbers of teeth.

9. The toothed gear wheel as claimed in claim 9,
wherein the number of teeth on each of the components is a primary number.

10. The toothed gear wheel as claimed in claim 1,
wherein the number of teeth on the component is a primary number.

11. A transmission with toothed gear wheels, comprising:
a tooth gear wheel as claimed in claim 1.

12. The transmission with toothed gear wheels as claimed in claim 12, comprising:
a toothed wheel pairing comprising the toothed gear wheel according to claim 1 and a further toothed gear wheel, which is not embodied in accordance with claim 1,
wherein the component of the toothed gear wheel being formed from a softer material than the second toothed gear wheel.

13. The transmission with toothed gear wheels as claimed in claim 12, comprising:
a toothed wheel pairing comprising the toothed gear wheel according to claim 1 and a further toothed gear wheel according to claim 1,
wherein the distribution of the teeth on the components differs in each toothed gear wheel.

14. A toothed gear wheel component, comprising:
one or more exchangeable teeth suitable for use in a toothed gear wheel in accordance claims 1 to 10,
wherein the toothed gear wheel component is detachably connectable to a toothed wheel body the toothed gear wheel.

15. A toothed gear wheel, comprising:
a toothed wheel body; and
an exchangeable tooth cover,
wherein the exchangeable tooth cover is detachably connected to the toothed wheel body of the toothed gear wheel
